(19) United States
(12) Patent Application Publication
(10) Pub. No.: US 2018/0051500 A1
(43) Pub. Date: Feb. 22, 2018

(54) SQUEAK-REDUCING HINGE ARRANGEMENT

(71) Applicant: THE HILLMAN GROUP, INC., Cincinnati, OH (US)

(72) Inventors: Farhad Lajewardi, Toronto (CA); Michael K. Falkenstein, Oakville (CA)

(21) Appl. No.: 15/375,238

(22) Filed: Dec. 12, 2016

Related U.S. Application Data
(60) Provisional application No. 62/376,694, filed on Aug. 18, 2016.

(51) Int. Cl. E05D 5/16; E05D 3/02; F16C 33/28; F16C 33/20

(52) U.S. Cl. CPC E05D 5/16; E05D 3/02; F16C 33/28; F16C 33/20; E05Y 2800/676; E05Y 2800/412; E05Y 2800/422; E05Y 2800/672; E05D 2003/025

(57) ABSTRACT

A hinge arrangement includes a first hinge component and a second hinge component and a hinge pin, where the first hinge component includes plurality of knuckles each having a respective bushing washer inserted therein. Each bushing washer includes a tubular bushing body inserted within its respective knuckle and an annular washer rim that unitary with the tubular bushing body and disposed atop its respective knuckle. An outer surface of each tubular bushing washer engages an inner surface of its respective knuckle to retain the bushing washer to the knuckle even when the hinge pin is removed and the second hinge component is separated from the first hinge component.

### TECHNICAL FIELD

This application relates generally to hinges and, more specifically, to a hinge arrangement that provides substantial reduction or elimination of squeaks without requiring the use of a lubricant.

### BACKGROUND

A barrel hinge utilizes two hinge plates having adjoining knuckles. One plate is attached to the door and the other plate is attached to the door frame. A hinge pin passes through aligned knuckles of the plates to join the plates. The hinge components are formed of metal for strength reasons, and the various rubbing surfaces can result in squeaks or other noise during pivoting of a door. Lubricants can be applied, but tend to create undesired mess and/or are only effective for a limited time. Various attempts to address the issues have been made in the past.

U.S. Pat. No. No. 3,921,225 discloses an assembly in which bushings are installed in a recess shaped internal feature of the hinge assembly. The arrangement produces a gap between hinge knuckles, but do not fill it, and also depends on a recessed shape in the hinge knuckle, which increase manufacturing complexity and cost.

U.S. Pat. No. 4,573,239 discloses an assembly that uses two opposing pins. The assembly also two opposed bushings in the same hinge knuckle. The bushings are ribbed to inhibit relative movement of the bushing in the hinge knuckle. The knuckle internal surfaces are also staked with prevailing features to also restrict relative motion of the pins. The assembly focuses on the manufacture of the complete hinge assembly, and appears to not allow for the separation of the door and supporting hinge.

U.S. Pat. No. 5,463,795 utilizes bored recesses on the bushings and counter bores in the interior of the hinge knuckles, and a metallic thrust bearing, with features to ensure that relative motion is minimized.

Accordingly, it would be desirable to provide a hinge arrangement adapted to overcome noise issues.

### SUMMARY

In one aspect, a hinge arrangement adapted for reducing wear and noise includes a first hinge component and a second hinge component. The first hinge component includes a first hinge plate and at least first and second vertically spaced apart and aligned knuckles at a hinge side of the first hinge plate. The second hinge component includes a second hinge plate and at least a third knuckle at a hinge side of the second hinge plate, wherein the hinge side of the second hinge plate is disposed proximate the hinge side of the first hinge plate, wherein the third knuckle is disposed between and aligned with the first and second knuckles to provide a pin passage therethrough. A first bushing washer has a first tubular bushing body inserted within the first knuckle, and a first annular washer rim unitary with the first tubular bushing body and disposed atop the first knuckle. A second bushing washer has a second tubular bushing body inserted within the second knuckle, and a second annular washer rim unitary with the second tubular bushing body and disposed atop the second knuckle. A third bushing washer has a third tubular bushing body inserted within the third knuckle, and a third annular washer rim unitary with the third tubular bushing body and disposed atop the third knuckle. A bottom side of the first knuckle seats atop the second annular washer rim to prevent contact between the first knuckle and the second knuckle and to act as a reduced friction bearing between the first knuckle and the second knuckle that limits wear and noise resulting from relative movement between the first knuckle and the second knuckle. A bottom side of the second knuckle seats atop the third annular washer rim to prevent contact between the second knuckle and the third knuckle and to act as a reduced friction bearing between the second knuckle and the third knuckle that limits wear and noise resulting from relative movement between the second knuckle and the third knuckle.

In another aspect, a hinge arrangement includes a plurality of knuckles each having a respective bushing washer inserted therein, where each bushing washer includes a tubular bushing body inserted within its respective knuckle and an annular washer rim unitary with the tubular bushing body and disposed atop its respective knuckle.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 shows a perspective front view of one embodiment of a hinge assembly;

FIG. 2 is a front elevation view of the hinge assembly of FIG. 1;

FIG. 3 is an exploded front elevation view of the hinge assembly of FIG. 1;

FIG. 4 is an explode perspective view of the hinge assembly of FIG. 1; and

FIG. 5 is a perspective view of one bushing washer;

FIG. 6 is an elevation view of the bushing washer of FIG. 5; and

FIG. 7 is another perspective view of the bushing washer of FIG. 5.

### DETAILED DESCRIPTION

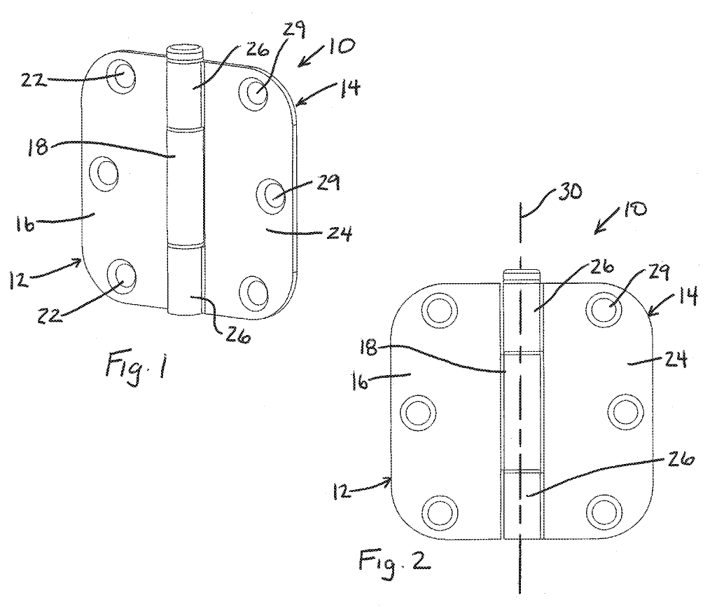

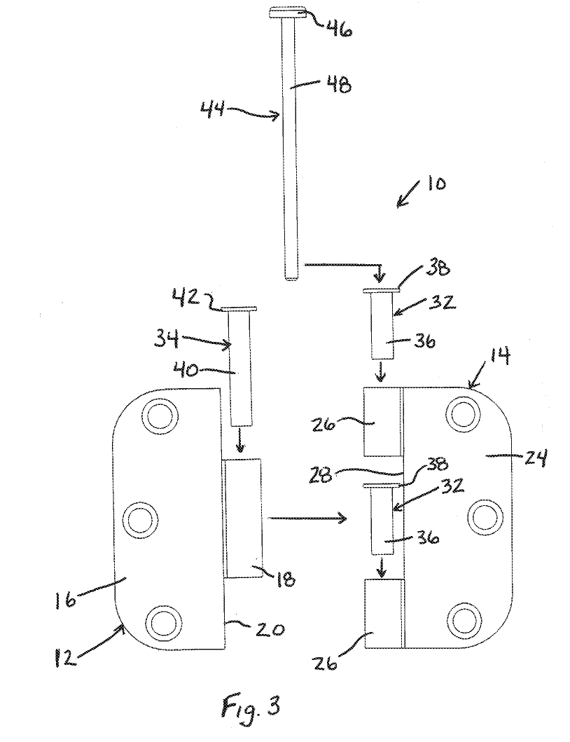

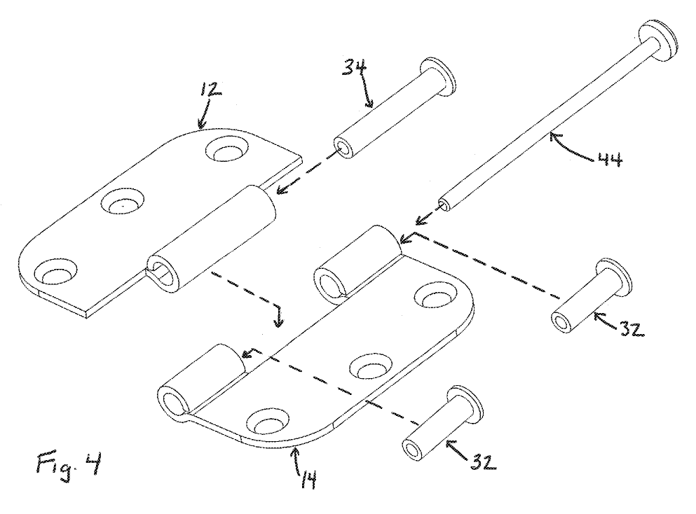

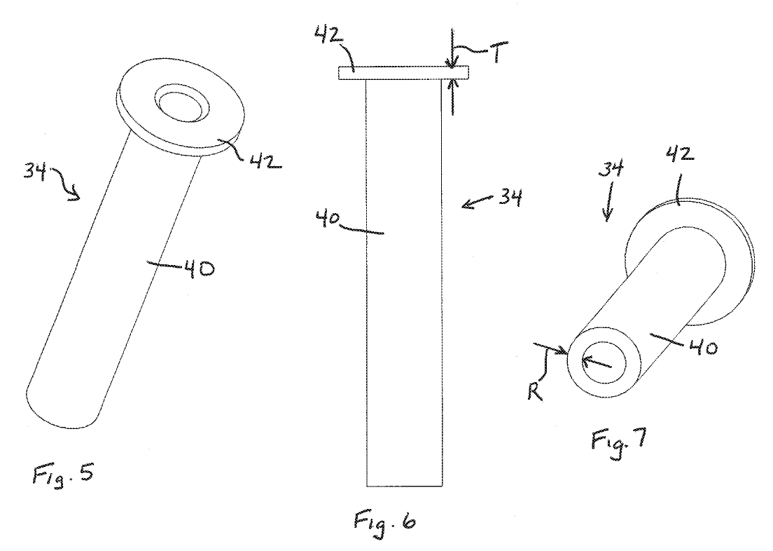

Referring now to FIGS. 1-7, a hinge assembly 10 is shown and includes a frame side hinge component 12 and a door side hinge component 14. Hinge component 12 includes a hinge plate 16 and knuckle (formed as a hinge loop) 18 at a pivot side 20 of the hinge plate. The hinge plate 16 includes a plurality openings 22 through which fasteners can be passed to secure the hinge plate 16 to a door frame. Hinge component 14 includes a hinge plate 24 and vertically spaced apart and aligned knuckles (formed as hinge loops) 26 at a pivot side 28 of the hinge plate 24. The pivot side 28 of the hinge plate 24 is disposed proximate the pivot side 20 of the hinge plate 16 in the assembled condition of the hinge assembly. In the illustrated embodiment, knuckle 18 is disposed between and aligned with the knuckles 26 in the assembled condition to provide a continuous pin passage therethrough (see axis 30 that is centrally aligned with the passage). Hinge plate 24 also includes a plurality openings 29 through which fasteners can be passed to secure the hinge plate 24 to a door frame.

In the illustrated embodiment, door side hinge component 14 includes two knuckles 26 and frame side hinge component 12 includes a single knuckle 18, but it is recognized that other variations as possible. For example, hinge arrangements in which both hinge components include two knuckles are possible, and hinge arrangements in which one hinge component includes three knuckles and the other hinge component includes two knuckles are possible, as well as other variations. It is contemplated that each hinge component will typically be formed of a metal (e.g., metal plate material cut to shape and then bent to form the knuckles), but other materials could be used, such as composites.

In the illustrated embodiment, knuckles 26 are of like dimensional height, and knuckle 18 has a substantially greater dimensional height than knuckles 26 (e.g., a height of the knuckle 18 is at least thirty percent greater than the height of the knuckles 26, such as at least fifty percent greater). However, other variations are possible.

Each knuckle 26 includes a corresponding bushing washer 32 disposed therein, and knuckle 18 includes a bushing washer 34 disposed therein. Bushing washers 32 are of like configuration and each have a tubular bushing body 36 that, in the assembled condition, is inserted within the internal passage of a respective knuckle 26, and an annular washer rim 38 unitary with and at the top of the tubular bushing body 36. The washer rims 38 are is disposed atop the knuckles 26 in which the tubular bushing body portion is inserted. Bushing washer 34 includes a tubular bushing body 40 that, in the assembled condition, is inserted within the knuckle 18, and a annular washer rim 42 unitary with the tubular bushing body 40 and that is disposed atop the knuckle 18.

A metal hinge pin 44 is disposed through the aligned knuckles 18 and 26 and, correspondingly the bushing washers 32 and 34. The length of the tubular bushing body 36 of each bushing washer 32 substantially corresponds to the height of the knuckles 26 (with the length typically being just slightly less (e.g., about 1% to 5% less) to assure that the tubular bushing body 36 does not extend below the bottom of the knuckle 26). Likewise, the length of the tubular bushing body 40 of bushing washer 34 substantially corresponds to the height of the knuckle 18 (with the length typically being just slightly less (e.g., about 1% to 5% less) to assure that the tubular bushing body 40 does not extend below the bottom of the knuckle 18). This configuration helps to assure that the entire length of the metal hinge pin shaft 48 is isolated from contact with the internal surfaces of the knuckles.

Notably, the hinge pin 44 includes a pin cap or head 46 seated atop the upper annular washer rim 38 to prevent the head 46 from contacting the upper knuckle 18, and the hinge pin shaft 48 is isolated from the interiors of the knuckles 18 and knuckle 26 by the tubular bushing bodies 36 and 40. Moreover, a bottom side of the upper knuckle 26 seats atop the annular washer rim 42 to prevent contact between the upper knuckle 26 and the knuckle 18, and a bottom side of the knuckle 18 seats atop the lower annular washer rim 38 to prevent contact between the knuckle 18 and the lower knuckle 26. The bushing washers may be formed of a polymer, thermoplastic material, and the elimination of the metal-to-metal contact eliminates or significantly reduces any squeaks or other noises and wear that can be caused during hinge operation (e.g., during opening or closing of a door).

In one implementation, each bushing washer 32 and 34 is formed of a polymer with between 0% and 40% (by weight) glass fiber. For example, the polymer may comprise Polyamide 6 or Polyamide 66 (exemplar brand Nylon 66), or some other thermoplastic, and may have between 10% and 40% glass fiber, such as between 20% and 35% glass fiber. In another example the polymer may comprise polyacetal (POM). Still other plastics, with or without glass fibers, could be used.

In order to provide desirable hinge appearance, the outer dimension (e.g., circumference or diameter) of all of the hinge knuckles 18 and 26 may be substantially the same, and the outer dimension of each of the annular washer rims 38 and 42 may be substantially the same as, or only slightly less than, the outer dimension of the knuckles. In addition, the plastic material of the bushing washers may be tinted to be consistent with (though not necessarily identical to) the color of the knuckles. Moreover, it is desirable to make the height or thickness dimension of each of the annular washer rims the same, and in most cases as small as practical to hold-up under hinge operation. In this regard, each annular washer rim may have a washer thickness (e.g., T in FIG. 6) of no more than about 80 thousandths of an inch (e.g., between about 20 thousandths and about 80 thousandths of an inch, such as between about 30 thousandths and 60 thousandths of an inch, such as between about 35 thousandths and about 45 thousandths of an inch). However, other variations are possible. In one implementation the wall thickness (e.g., radial thickness R in FIG. 7) of each tubular bushing body may be no more than about 60 thousandths of an inch (e.g., such as no more than about 50 thousandths of an inch). In certain implementation the wall thickness of the tubular bushing body may be less than the washer thickness.

The bushing washer tubular bushing bodies 36 may, in some implementations, have outside diameters sized to fit snugly within the knuckles 26, and the bushing washer tubular bushing body 40 may have an outside diameter sized to fit snugly within the knuckle 18 (e.g., by a friction fit of the outer surface of the bushing body with the inner surface of the knuckle), thereby retaining the bushing washers in place even when the hinge is disassembled. Because the annular washer rims are unitary with the tubular bushing bodies, the annular washer rims are also maintained in desired positions. In the illustrated embodiment, the external surfaces of the bushing washer tubular bushing bodies 36 and the external surface of bushing washer tubular bushing body 40 are substantially smooth, without any ridges, grooves or other projections. Likewise, the interior surfaces of the knuckles 26 and the interior surface of knuckle 18 are substantially smooth, without and ridges, grooves or other projections. This configuration may enable rotation of the bushing washers 32 and 34 relative to the respective knuckles 26 and 18 without damaging the bushing washers.

The bushing washers, being of substantially all, or even 100%, plastic material or plastic with glass fiber to increase wear, act as reduced friction bearings that absorb the loads in the vertical direction (the annular washer rims absorb the vertical loads) and consequently limit or prevent squeak noise and wear, increasing the life of the door hinges. In addition, the tubular bushing bodies isolate the metal contact in the radial direction between the outer surface of the metal hinge pin shaft and the inner surfaces of the metal knuckles, and absorb the lateral loads, to eliminate or reduce squeak noise and wear between such surfaces.

The hinge arrangement provides performance improvement with squeak free and no or reduced wear on parts, process improvement in terms of hinge assembly, cost-effective manufacturing by making the tubular bushing body and annular rim washer as a unitary component (e.g., molded as one monolithic piece), and utilizing plastic material (e.g., 100% plastic, or plastic with glass fiber for increased wear). The unitary bushing washer performs both as a bushing washer, to support the bearing loads, lateral loads, alignment, and also to prevent wear and squeak noise between two metals. The unique and innovative configuration of the bushing washer provides longer life of door hinges with easier assembly and a manufacturing process which is cost effective.

It is to be clearly understood that the above description is intended by way of illustration and example only, is not intended to be taken by way of limitation, and that other changes and modifications are possible.

What is claimed is:

1. A hinge arrangement adapted for reducing wear and noise, comprising:
a first hinge component including a first hinge plate and at least first and second vertically spaced apart and aligned knuckles at a hinge side of the first hinge plate;
a second hinge component including second hinge plate and at least a third knuckle at a hinge side of the second hinge plate, wherein the hinge side of the second hinge plate is disposed proximate the hinge side of the first hinge plate, wherein the third knuckle is disposed between and aligned with the first and second knuckles to provide a pin passage therethrough;
a plurality of bushing washers comprised of plastic, including:
a first bushing washer that functions both as a bushing and a washer, the first bushing washer having a first tubular bushing body inserted within the first knuckle, and a first annular washer rim unitary with the first tubular bushing body and disposed atop the first knuckle,
a second bushing washer that functions both as a bushing and a washer, the second bushing washer having a second tubular bushing body inserted within the second knuckle, and a second annular washer rim unitary with the second tubular bushing body and disposed atop the second knuckle, and
a third bushing washer that functions both as a bushing and a washer, the third bushing washer having a third tubular bushing body inserted within the third knuckle, and a third annular washer rim unitary with the third tubular bushing body and disposed atop the third knuckle;
wherein the first, second and third bushing washers cooperate to support bearing loads, support lateral loads, provide alignment, and to limit wear and squeak noise in the hinge arrangement;
wherein a bottom side of the first knuckle seats atop the second annular washer rim to prevent contact between the first knuckle and the second knuckle and to act as a reduced friction bearing between the first knuckle and the second knuckle that limits wear and noise resulting from relative movement between the first knuckle and the second knuckle, and a bottom side of the second knuckle seats atop the third annular washer rim to prevent contact between the second knuckle and the third knuckle and to act as a reduced friction bearing between the second knuckle and the third knuckle that limits wear and noise resulting from relative movement between the second knuckle and the third knuckle.

2. The hinge arrangement of claim 1, further comprising:
a single hinge pin disposed through the pin passage formed by the aligned first, second and third knuckles and, correspondingly, through the first tubular bushing body, the second tubular bushing body and the third tubular bushing body, which collectively isolate the hinge pin from internal surfaces of the first, second and third knuckles, where the hinge pin includes a pin cap seated atop the first annular washer rim to reduce wear and noise resulting from relative movement between the pin cap and the first knuckle.

3. The hinge arrangement of claim 1 wherein the second hinge component includes a fourth knuckle disposed below the second knuckle, and a fourth bushing washer is disposed within the fourth knuckle.

4. The hinge arrangement of claim 1 wherein the first tubular bushing body fits snugly within the first knuckle, the second tubular bushing body fits snugly within the second knuckle and the third tubular bushing body fits snugly within the third knuckle.

5. The hinge arrangement of claim 1 wherein each bushing washer is formed of a polymer material with between 0% and 40% by weight glass fiber.

6. The hinge component of claim 5 wherein each bushing washer is formed of a polymer material with between 10% and 40% by weight glass fiber.

7. The hinge arrangement of claim 5 wherein the polymer material comprises a thermoplastic.

8. The hinge arrangement of claim 7 wherein the polymer material comprises Polyamide 66 material and contains between 10% and 40% by weight glass fiber.

9. The hinge arrangement of claim 5 wherein the polymer material comprises polyacetal.

10. The hinge arrangement of claim 1 wherein the first annular washer rim, the second annular washer rim and the third annular washer rim each have a thickness of no more than about 80 thousandths of an inch.

11. The hinge arrangement of claim 1 wherein the first annular washer rim, the second annular washer rim and the third annular washer rim each have a thickness of no more than about 50 thousandths of an inch.

12. The hinge arrangement of claim 1 wherein the first annular washer rim, the second annular washer rim and the third annular washer rim each have a thickness of between about 30 thousandths and about 50 thousandths of an inch.

13. The hinge arrangement of claim 12 wherein the first tubular bushing body, the second tubular bushing body and the third tubular bushing body each have a wall thickness of no more than 50 thousandths of an inch.

14. The hinge arrangement of claim 12 wherein the first tubular bushing body has a wall thickness that is less than the thickness of the first annular washer rim, the second tubular bushing body has a wall thickness that is less than the thickness of the second annular washer rim and the third tubular bushing body has a wall thickness that is less than the thickness of the third annular washer rim.

15. The hinge arrangement of claim 1 wherein each of the first annular washer rim, the second annular washer rim and the third annular washer rim is tinted to be consistent with a color of the first, second and third knuckles.

16. The hinge arrangement of claim 1 wherein an outer diameter of each of the first, second and third annular washer rims is substantially the same as an outer diameter of each of the first, second and third knuckles.

17. The hinge arrangement of claim 1 wherein an outer diameter of each of the first, second and third annular washer rims is at least 95% of an outer diameter of each of the first, second and third knuckles.

18. The hinge arrangement of claim 1 wherein an outer surface of each of the first, second and third annular washer rims is sized to be substantially flush with outer surfaces of any adjacent first, second or third knuckle.

19. The hinge arrangement of claim 1 wherein the first knuckle includes a substantially planar top portion upon which the first annular washer rim sits so that the first annular washer rim is not recessed into the first knuckle, the second knuckle includes a substantially planar top portion upon which the second annular washer rim sits so that the second annular washer rim is not recessed into the second knuckle, and the third knuckle includes a substantially planar top portion upon which the third annular washer rim sits so that the third annular washer rim is not recessed into the third knuckle.

20. The hinge arrangement of claim 1 wherein a height the first knuckle is substantially the same as a height of the second knuckle, and a height of the third knuckle is at least thirty percent greater than the height of the first knuckle.

21. The hinge arrangement of claim 20 wherein a length of the first bushing washer is substantially the same as a length of the second bushing washer, and a length of the third bushing washer is at least thirty percent greater than the length of the first bushing washer.

22. The hinge arrangement of claim 20 wherein the height of the third knuckle is at least fifty percent greater than the height of the first knuckle.

23. A hinge arrangement adapted for reducing wear and noise, comprising:
a first hinge component including a first hinge plate and at least a first knuckle and a second knuckle at a hinge side of the first hinge plate;
a second hinge component including a second hinge plate and at least a third knuckle at a hinge side of the second hinge plate, wherein the hinge side of the second hinge plate is disposed proximate the hinge side of the first hinge plate, wherein the third knuckle is disposed between and aligned with the first knuckle and the second knuckle to provide a pin passage therethrough;
a plurality of bushing washers comprised of plastic, including:
a first bushing washer having a first tubular bushing body and a first annular washer rim molded as a monolithic piece, the first tubular bushing body inserted within the first knuckle, the first annular washer rim disposed atop the first knuckle,
a second bushing washer having a second tubular bushing body and a second annular washer rim molded as a monolithic piece, the second tubular bushing body inserted within the second knuckle, the second annular washer rim disposed atop the second knuckle, and
a third bushing washer having a third tubular bushing body and a third annular washer rim molded as a monolithic piece, the third tubular bushing body inserted within the third knuckle, the third annular washer rim disposed atop the third knuckle;
wherein the first, second and third bushing washers cooperate to support bearing loads, support lateral loads, provide alignment, and to limit wear and squeak noise in the hinge arrangement;
wherein a bottom side of the first knuckle seats atop the second annular washer rim to prevent contact between the first knuckle and the second knuckle and to act as a reduced friction bearing between the first knuckle and the second knuckle that limits wear and noise resulting from relative movement between the first knuckle and the second knuckle, and a bottom side of the second knuckle seats atop the third annular washer rim to prevent contact between the second knuckle and the third knuckle and to act as a reduced friction bearing between the second knuckle and the third knuckle that limits wear and noise resulting from relative movement between the second knuckle and the third knuckle;
a hinge pin disposed through the pin passage formed by the aligned first, second and third knuckles and, correspondingly, through the first tubular bushing body, the second tubular bushing body and the third tubular bushing body such that the hinge pin is isolated from contact with internal surfaces of the first, second and third knuckles, where the hinge pin includes a pin cap seated atop the first annular washer rim to reduce wear and noise resulting from relative movement between the pin cap and the first knuckle;
wherein each bushing washer is formed of a polymer material with between 10% and 40% by weight glass fiber;
wherein the first annular washer rim, the second annular washer rim and the third annular washer rim each have a thickness of no more than about 70 thousandths of an inch;
wherein an outer surface of each of the first, second and third annular washer rims is sized to be substantially flush with outer surfaces of any adjacent first, second or third knuckle.
